(19) United States
(12) Patent Application Publication
(10) Pub. No.: US 2005/0209355 A1
(43) Pub. Date: Sep. 22, 2005

(54) [Novel Reactions and the Products of Such Reactions]

(76) Inventor: Lipa Leon Roitman, Dayton, OH (US)

Correspondence Address: LIPA ROITMAN, 300 OTTERBEIN AVENUE, DAYTON, OH, 45406, US

(21) Appl. No.: 10/708,732

(22) Filed: Mar. 22, 2004

(51) Int. Cl. C08G 2/00

(52) U.S. Cl. 522/1

(57) ABSTRACT

A process for the synthesis of novel compounds is described comprising reacting tetrachloroethylene with substances containing active methylene group in the presence of free radical initiators. Also, a process for grafting tetrachloroethylene is described comprising reacting these compounds with polymers containing active methylene group in the presence of free radical initiators. Furthermore, a method of conducting such reactions to high conversion is described, comprising conducting the reactions in the reflux condensate. The present invention provides a novel and high yield route for heretofore unobtainable materials.

### BACKGROUND OF INVENTION

The present invention relates to the organic synthesis and graft polymerizations, especially as applied to the creation of a carbon-carbon bond, and also to the synthesis of graft polymers, and to the reaction set-up for difficult-to-conduct reactions.

Tetrachloroethylene is not known to polymerize or copolymerize under normal free radical polymerization conditions, and it is often used as an inert solvent in polymerizations, such as in the US Patent by Koda at al U.S. Pat. No. 6,635,727. Oct. 21, 2003. Surprisingly, I have discovered that in presence of free-radical initiators it reacts rather readily with certain materials, and grafts to certain polymers, in a unique addition-elimination reaction. Although the reaction tends to stall in the normal reaction conditions, I've found a way to drive it to completion. Other not known to be polymerizable materials like trichoroethylene, mixed trihaloethylenes and tetrahaloethylenes, hexachlorobutadiene, and hexachlorocyclopentadiene may by made to react in such way.

Disclosed here is an improved reaction set-up which allows driving this reaction to completion, and which results in more efficient catalyst utilization and a higher purity product. This set-up can also be applied to other reagents, and to other difficult-to-run reactions, where the accumulating impurities and the reaction product interfere with the reaction progress.

### SUMMARY OF INVENTION

One object of the present invention is to disclose a reaction that leads to novel previously unattainable compounds and graft copolymers. In the presence of free radical initiators, (also referred to herein as catalysts), Group 1 reagents add to Group 2 reagents with subsequent elimination of hydrogen chloride. Group 1 reagents referred herein are tetrachloroethylene and also hexachlorocyclopentadiene, trichloroethylene, mixed trihaloethylenes and tetrahaloethylenes, and hexachlorobutadiene. Group 2 reagents or Group 2 substrates, referred herein are compounds and polymers that contain an active methylene group which is adjacent to at least one electron withdrawing group such as ester, ether, carbonyl, nitrile, amide, nitro, sulfoxy, carbamyl, hydroxyl, or an aromatic ring groups. This invention discloses that such active methylene group compounds are especially susceptible to the free-radical catalyzed reaction with Group 1 reagents.

Furthermore, another object of the present invention is to provide a method for increasing the yield of these reactions. If conducted in a regular batch or semi-batch way, this reaction results in incomplete conversion and, as the process progresses, it consumes increased amounts of initiators with no increase in yield. It appears that the reaction product or the impurities accumulating during the reaction quench the free radicals, and after a while prevent further reaction. This results in incomplete conversion and difficulties in product purification. I have subsequently found a method allowing driving the reaction to completion. The improved reaction set-up disclosed here also results in more efficient initiator utilization and a higher purity product.

Another object of the present invention is to provide a method for efficient grafting of Group 1 reagents, and other difficult-to-react monomers, with Group 2 polymers to produce graft-modified polymers. The new method improves the graft efficiency, prevents polymer cleavage, crosslinking and side reactions.

In the improved method of this invention the free radical initiator solution in Group 1 reagent is gradually added into the stream of reflux condensate, while the reagents are continually refluxing. Thus most of the reaction occurs in the clean reflux condensate, while the interfering byproducts and the reaction product are accumulated in the main vessel. To increase the dwelling time of the initiator in the reflux condensate, the condensate is continuously pooled (collected) in the second vessel, to which the initiator solution is added, and from which the reaction mixture is continuously or periodically discharged into the main vessel. The reagents keep circulating in the reflux and react with the free radicals in the condensate. Also, to further stabilize the reaction product, free radical quencher is added to the main vessel. Thus the main vessel serves as the product concentrator, and the second one as the reactor. An example of this two-vessel set-up is provided.

The same improved reaction set-up also allows grafting Group 1 reagents onto the insoluble substrates and polymers. This can be done by placing the substrate in the stream of Group 1 reagents reflux condensate in the second vessel, and gradually adding the free radical initiator solution. This set-up creates favorable conditions for a grafting reaction.

The method of this invention opens a route towards many heretofore unavailable materials with many potential uses.

### BRIEF DESCRIPTION OF DRAWINGS

FIG. 1 illustrates the tetrachloroethylene reaction with activated methylene compounds. In this drawing X is an ester, ether, carbonyl, nitrile, amide, nitro, sulfoxy, carbamyl, hydroxyl, or an aromatic ring group; R1, R2, and R3 can be any radical or part of a more complex structure (polymer, ring, etc.) In this reaction tetrachloroethylene and the target carbon atom on Group 2 molecule participate in a coupling reaction, in which C—H group first adds to the double bond of the tetrachloroethylene, then the hydrogen chloride molecule splits off, re-creating the double bond.

FIG. 2 and FIG. 3 show the preferred reaction set-up in two different, but functionally equivalent embodiments. This set-up consists of the Vessel 1 and Vessel 2, which are connected through a Vapor/Liquid Path 4, (FIG. 2) or Vapor only Path 4, (FIG. 3), which may comprise a fractionation column, and Liquid Path 6. Reflux condenser 5, and the Catalyst/Reagent Feed Valve(s) 9 are also connected to the Vessel 2. Together these elements create a loop with a feed allowing continuous distillation and reaction of the low-boiling reagents in Vessel 2, while the high-boiling product and by-products remain in Vessel 1.

### DETAILED DESCRIPTION

This invention teaches reacting Group 1 reagents with Group 2 reagents in the presence of a free-radical initiator. The Group 2 reagents or substrates most susceptible to such reactions contain active methylene or methyne group, which is adjacent to at least one strong electron withdrawing group such as the oxygen of hydroxyl, ester, ether, sulfoxy, cyano, carbonyl carbamyl or an aromatic ring groups.

The Group 2 compounds can be represented by a general formula R1R2CH—XR3, where X is an oxygen, and R1, R2, and R3 are any radical or part of a more complex structure (polymer, ring, etc.). Especially suitable are compounds where R3 is an alkyl, acyl, aryl, sulfoxyl, nitroxyl, carbonyl or carbamyl (RNHCO—). In another group of suitable compounds X is a carbonyl.

The products of the reaction of Group 1 reagents with Group 2 compounds can be represented by a formula R1R2YC—XR3, where X is and oxygen or carbonyl, and R1, R2, and R3 are any radical or part of a more complex structure (polymer, ring, etc.). In particular, R3 is an alkyl, acyl, aryl, sulfoxyl, nitroxyl, carbonyl or carbamyl (RN—HCO—), and Y is trihalovinyl, dihalovinyl, pentahalobutadienyl, or pentahalorocyclopentadienyl and in particular, trichlorovinyl, dichlorovinyl, pentachlorobutadienyl, or pentachlorocyclopentadienyl.

The carbon-hydrogen bond of the active methylene or methyne group is the preferred target location for such reaction. However, when the Group 2 substrate contains OH, NH2 or NH groups which compete with the active methylene or methyne groups in grafting, the initiator may remove the active hydrogen from these groups, resulting in an oxygen-carbon or nitrogen-carbon adduct structure, such as trichlorovinyl ether along with the desired carbon-carbon bond. Therefore any such group present should be protected for instance, OH by esterification, or with acetal group, to prevent competing reactions. For the same reason the reagents should be thoroughly dried before the reaction. Similar protection, like acetylation or alkylation could be applied to NH or NH2 groups. Also, when the Group 2 substrate contains polymerizable double bonds or other groups susceptible to attack by free radicals, a suitable protection should be employed, such as hydrohalogenation or other methods commonly employed by those skilled in the art.

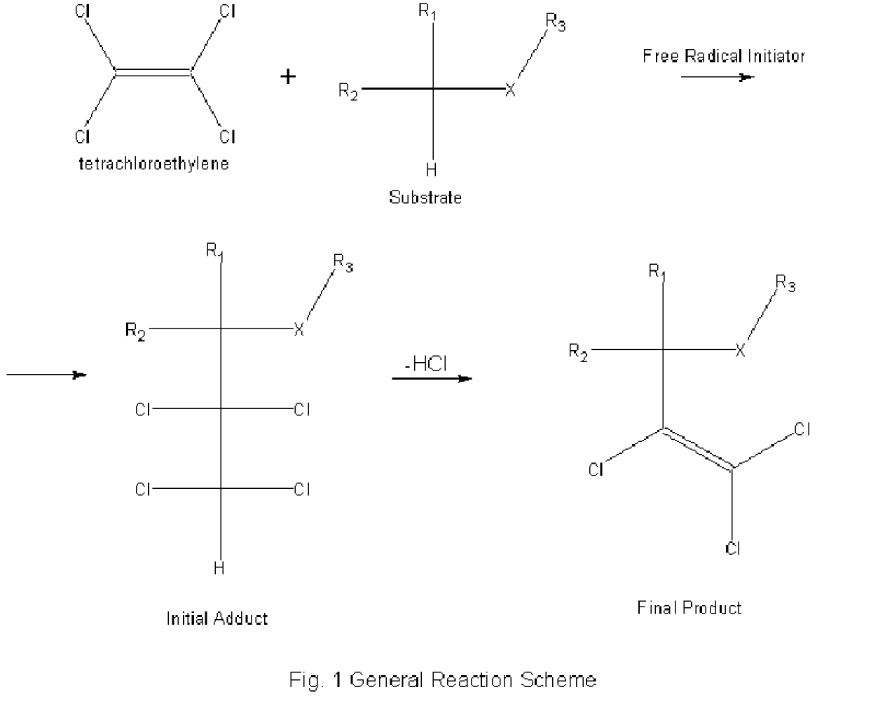

FIG. 1 shows the general schematics of the reaction of this invention. In this reaction Group 1 tetrachloroethylene and the target carbon atom on Group 2 molecule participate in a coupling reaction, in which C—H group first adds to the double bond of the tetrachloroethylene, then the hydrogen chloride molecule splits off, re-creating the double bond. Presumably that occurs through the initial abstraction of hydrogen atom from the C—H bond by the free-radical initiator. Although the initial adduct can sometimes be isolated, it is not heat-stable, and usually under-goes in-situ dehydrochlorination, resulting in the double bond. Thus the net result is the substitution of the hydrogen atom of the C—H bond with trichlorovinyl group with the elimination of HCl. The resulted product contains only graft-copolymer and no tetrachloroethylene homopolymer, since it does not appear to react with itself.

Many materials that contain active methylene or methyne group can participate in such reaction. Even insoluble polymers like cellulose fibers can be grafted with the setup disclosed below. Also, surface modification of polymer-made articles is possible. The non-exclusive list of such materials is comprised of alcohol, ester, ether or carbonyl groups, such as short and long-chain alcohols and their esters with carboxylic acids, lactones, polyesters from aliphatic diols, alkyl acetate, 1,4-dioxane, ethyl formate, propyl formate, butyl formate, isobutyl formate, amyl formate, methyl acetate, ethyl acetate, propyl acetate, isopropyl acetate, butyl acetate, isobutyl acetate, secondary butyl acetate, amyl acetate, isoamyl acetate, methylisoamyl acetate, methoxybutyl acetate, 2-ethylbutyl acetate, hexyl acetate, cyclohexyl acetate, benzyl acetate, methyl propionate, ethyl propionate, butyl propionate, amyl propionate, methyl butyrate, ethyl butyrate, butyl butyrate, amyl butyrate, isoamyl butyrate, methyl acetoacetate, ethyl acetone acetate, isoamyl isovelerate, methyl lactate, ethyl lactate, butyl lactate, amyl lactate, methyl benzoate, diethyl oxalate, ethylene glycol, ethylene glycol monomethyl ether, ethylene glycol monomethyl ether acetate, ethylene glycol dimethyl ether, ethylene glycol monoethyl ether, ethylene glycol diethyl ether, ethylene glycol monoethyl ether acetate, ethylene glycol isopropyl ether, ethylene glycol monobutyl ether, ethylene glycol monoisobutyl ether, ethylene glycol dibutyl ether, ethylene glycol monobutyl ether acetate, ethylene glycol isoamyl ether, ethylene glycol monohexyl ether, ethylene glycol monophenyl ether, ethylene glycol monophenyl ether acetate, ethylene glycol benzyl ether, methoxymethoxyethanol, ethylene glycol monoacetate, ethylene glycol diacetate, ethylene glycol butyric monoester, ethylene glycol propionic diester, ethylene glycol butyric diester, diethylene glycol, diethylene glycol monomethyl ether, diethylene glycol monoethyl ether, diethylene glycol monomethyl ether acetate, diethylene glycol monoethyl ether acetate, diethylene glycol monoisopropyl ether, diethylene glycol monobutyl ether, diethylene glycol monoisobutyl ether, diethylene glycol monobutyl ether acetate, diethylene glycol dimethyl ether, diethylene glycol diethyl ether, diethylene glycol methyl ethyl ether, diethylene glycol acetate, diethylene glycol dibutyl ether, propylene glycol, propylene glycol monomethyl ether, propylene glycol monoethyl ether, propylene glycol monomethyl ether acetate, propylene glycol propyl ether, propylene glycol monoethyl ether acetate, propylene glycol monobutyl ether, dipropylene glycol, dipropylene glycol monomethyl ether, dipropylene glycol monoethyl ether, dipropylene glycol dimethyl ether, dipropylene glycol methyl ethyl ether, dipropylene glycol diethyl ether, trimethylene glycol, triethylene glycol dimethyl ether, butanediol, pentanediol, hexylene glycol, 3-methoxy-3-methoxybutanol, triethyl phosphate, .gamma.-butyrolactone, .gamma.-valerolactone, 6-hexanolactone, ethyl salicylate, butyl salicylate, diethyl adipate, ethyl carbonate, butyl sulfide, acetylacetone, ethyl acetate, ethyl propionate, ethyl butyrate, propyl acetate, iso-propyl acetate, n-butyl acetate, sec-butyl acetate, amyl acetate, benzyl acetate, hexyl acetate, heptyl acetate, octyl acetate, decyl acetate, dodecyl acetate, hexadecyl acetate, 1-methoxy-2-propanol acetate, butyl phthalate, benzyl acetate, furfuryl acetate, tetrahydrofurfuryl acetate, polyethylene terephthalate, epichlorohydrine, epoxy resins, gamma-butyrolactone, hydroxy-gamma-butyrolactone, acetoxy-gamma-butyrolactone, poly-beta-hydroxybutyrate, polylactide, tetrahydrofurane, morpholine, N-methylmorpholine, N-methylmorpholine N-oxide, 4-alkylmorpholine, diethyl ether, isopropyl ether, dibutyl ether, diisoamyl ether, hexyl ether, ethyl phenyl ether, butyl phenyl ether, ethyl benzyl ether, 2-methylfuran, tetrahydrofuran, tetrahydropyran, 2-ethoxytetrahydropyran, acetone, methyl ethyl ketone, cineole, acetone, methyl propyl ketone, methyl butyl ketone, methyl isobutyl ketone, methyl amyl ketone, methyl hexyl ketone, diethyl ketone, ethyl butyl ketone, dipropyl ketone, diisobutyl ketone, diacetone alcohol, phorone, isophorone, cyclohexanone, methylcyclohexanone, acetophenone, 1,3-diphenyl-2-propanone, benzoylacetonitrile, hydrocinnamonitrile, dibenzyl sulfoxide, ethylvinyl sulfone, dialkyl sulfone, alkylphenyl sulfone, acetonitrile, cyanoacetamide, and 1,3-cyclohexanedione, polyvinyl benzoate, polyvinyl propionate, polyvinyl butyrate, polyvinyl phthalate, fatty acid mono-, di-, and triglycerides, other glycerol esters and ethers, pentaerytritol esters and ethers, glucose, sucrose, sucrose esters, acetyl cellulose, alkyl, alkylhydroxyalkyl, hydroxyalkyl, and carboxyalkyl cellulose ethers.

Any free radical initiator may be used in carrying out the process of the present invention. A free radical initiator is a chemical substance that initiates chemical reactions by producing free radicals. For further information, reference is made to Kirk Othmer's Encyclopedia of Chemical Technology, Vol. 14, p. 431. Each such initiator commonly has a characteristic minimum reaction initiation temperature, above which it will readily initiate a reaction and below which the reaction will proceed more slowly or not at all. In the preferred set-up, the free radical catalyst or the catalyst system should be selected to quickly decompose to radicals at the reaction temperature.

In the embodiments given in the examples, benzoyl peroxide is used as the free radical catalyst. However, anyone skilled in art can use other initiators and modify the reaction conditions accordingly, without departing from the scope of this invention. When the need arises to conduct the reaction at lower or higher temperature, an appropriate for that temperature initiator may be chosen. Each initiator has a known half-life at certain temperature. Examples of the free radical initiator include organic and inorganic peroxides such as benzoyl peroxide, t-butyl peroxybenzoate, dicumyl peroxide, t-butyl hydroperoxide, t-butyl peroxyacetate, diisopropylperoxy dicarbonate, 2,2-bis(t-butylperoxy)octane, methyl ethyl ketone peroxide, potassium peroxide and hydrogen peroxide; and azo compounds such as .alpha.,.alpha.′-azobisisobutyronitrile. The peroxides can act as redox type catalysts when they are used in combination with a reducing agent. Thus benzoyl peroxide may be combined with N,N-dimethylaniline to create free radicals at room temperature. Nonchemical means of free radicals generation can also be used, and they include ultrasound, UV light, ionizing radiation, and the like.

The standard reaction set-up: The regular reaction set-up (not the preferred one, which is disclosed below), is by heating a solution of the Group 2 reagent in excess Group 1 reagent as a solvent under nitrogen in presence of free radical initiator at 60 to 120° C., and preferably at about 80 to 100° C. These temperatures are suitable for the benzoyl peroxide catalyst used in these examples. However, anyone skilled in art can use other initiator, and adjust the reaction temperature and pressure according to the halflife of the free radical initiator, or chose a catalyst with the half-life suitable for the desirable temperature, without departing from the scope of this invention.

It is better to adjust the pressure or vacuum to have the reaction mixture reflux at the preferred 80 to 100° C. Reflux helps removing the hydrogen chloride gas, a by-product. It is also better to gradually add the initiator solution in Group 1 reagent over several hours period rather than adding all at once.

The progress of the reaction can be monitored by measuring the evolution of hydrogen chloride gas. Also, if the Group 2 reagent is a liquid, the boiling point of the mixture will increase with conversion.

Shortcoming of the standard reaction set-up: In the regular batch or semi-batch reaction set-up the initiator solution is added directly to the refluxing reaction mixture. With this set-up the initiator loses efficiency after a short time, and the reaction stalls after four to six hours, when the conversion is only partial. Attempting longer reaction times and adding more initiator results in increased impurities and does not improve yield. It appears that some impurities or the main reaction product accumulate during the reaction and quench the free radicals. Any additional initiator added at that time is wasted through unproductive reactions, leading to more side reactions and more impurities. Excess free radicals also attack the product resulting in even lower yield, and, if the substrate is the polymer, the result is chain cleavage, crosslinking and other side reactions. Thus the process must be terminated early, and the product has to be isolated from the large amount of unreacted material.

The preferred reaction set-up: In the following is disclosed a method to prevent these complications. With this preferred set-up the reaction can be driven to completion, and the product purity is higher, with less side reactions, and furthermore, the catalyst is utilized much more efficiently.

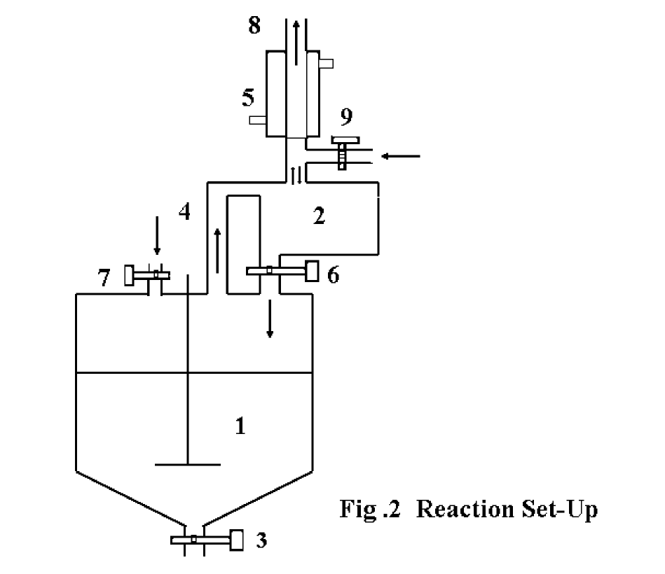

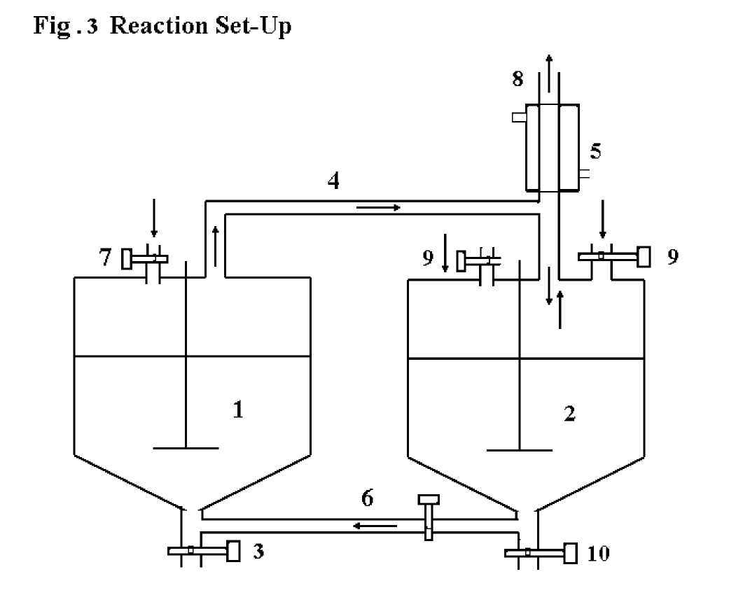

The preferred reaction set-up which overcomes this problem is shown in FIG. 2 and FIG. 3 in two different, but functionally equivalent embodiments. This set-up consists of the Vessel 1 and Vessel 2, which are connected through a Vapor/Liquid Path 4, (FIG. 2) or Vapor only Path 4, (FIG. 3) and Liquid Path 6. Reflux condenser 5, and the Catalyst/Reagent Feed Valve(s) 9 are also connected to the Vessel 2. Together these elements create a loop with a feed allowing continuous distillation and the reaction of the reagents, which loop consists of the following steps: a) vaporizing in the Product Concentrator Vessel 1, b) then the vapors go up through the Tube 4, c) then the vapors condense in a Reflux Condenser 5, d) then the reflux condensate is collected in the Reaction Vessel 2, to which the catalyst alone, or catalyst and one or both reagents are also being added through the Valve 9, and where the reaction occurs, then e) the liquid reacted mixture returns into the Product Concentrator Vessel 1 through either Valve 6 or Tube 4 (or both), then back to vaporizing in step a), and so on, until the reagents are fully reacted.

First, a mixture of the Group 2 substrate and Group 1 reagent such as tetrachloroethylene is placed into the Vessel 1 and heated to the reflux. Equimolar mixture of the Group 2 substrate and Group 1 reagent is also pre-charged to the Vessel 2. The temperature is chosen within the Group 2 reagent stability range, and preferably should be between 50 and 120° C. Then the vacuum (or pressure), is adjusted to reflux the mixture at the chosen temperature. Preferably, the initial molar ratio of the Group 2 reagent to Group 1 reagent (M2/M1) in the Vessel 1 should be approximately the inverse of the ratio of the vapor pressures of the Group 2 reagent (VP2) to Group 1 reagent (VP1), according to the following formula: M2/M1=VP1/VP2, in order to equalize the reactants ratios in the vapors.

Some combinations of Group 1 and Group 2 reagents are more amenable to the preferred reaction set-up, such as those that boil at about the same temperature, or form an azeotrope. If possible, Group 2 substrate should be modified to match the boiling point of the Group 1 reagent by using appropriate modifications. For example, when choosing the acid with which to esterify the hydroxyl group, one can pick the one resulting in the boiling point of the substrate ester being close to the boiling point of the desired Group 1 reagent. An example of such modification is given below.

Next the free radical catalyst or catalyst solution in Group 1, Group 2, or a mixture of reagents is gradually added into the clean reflux condensate in the Vessel 2, which serves as the reaction zone, while the reagents are continuously distilled along the aforementioned loop. The free-radical catalyst is selected which can quickly decompose to free radicals at the temperature in the Vessel 2. A redox system for free radicals generation may also be chosen, as well as UV irradiation or other physical method.

Since the product of this coupling reaction is necessarily higher-boiling than either of the reagents, it is accumulating in the Product Concentrator Vessel 1 along with the reaction by-products, while the unreacted Group 1 reagent, and the Group 2 reagent vapors keep circulating with the reflux until they react completely.

Another embodiment of this process is when the Group 2 reagent and Group 1 reagent, and the catalyst are being added to the Vessel 2 as the reaction proceeds.

Another embodiment of this process is when the reaction mixture is being removed from the Vessel 1 through Valve 3 as the reaction proceeds.

Another embodiment of this process is when the Group 1 reagent, Group 2 reagent, and the catalyst are being added to the Vessel 2, and the reaction mixture is being removed from the Vessel 1 through Valve 3 as the reaction proceeds. This creates a set-up for a continuous steady-state process.

The process is preferably conducted under the flow of nitrogen, which helps removing HCl by-product. Nitrogen is shown here entering through a valve 7, and exiting, together with the HCl through the top of the reflux condenser.

Vessel 1 is commonly stirred. Vessel 2 is optionally stirred.

Vessel 1 can optionally contain non-volatile free radical inhibitor. This inhibitor should quench free radicals, and prevent side reactions that may occur when the residual unreacted free radical initiator may get there from the Vessel 2.

Also, a base or an acid scavenger like alkali or alkali earth metal oxide, hydroxide, peroxide, carbonate, percatbonate, like sodium carbonate, calcium carbonate, aluminum hydroxide, sodium hydroxide or sodium bicarbonate, or organic liquid or solid or polymeric acid scavenger or base, can optionally be present in the Vessel 1. An alternative embodiment would be in placing stoichiometric amounts of the acid scavenger in the Vessel 2; such design would essentially replace the external HCl scrubber with the internal one. Alternatively the base is gradually added to the Vessel 2 along with other reagents.

Another embodiment would be in creating the free radical initiators in-situ from alkali earth metal peroxide and acid chloride or anhydride, like benzoyl chloride or acetic anhydride. This operation can be preceded or combined with the esterification of the free hydroxy groups on Group 2 reagent, in order to protect them from halovinyl ether formation.

Controlling the preferred process: As fresh portion of the free radical initiator solution is added to the Reaction Vessel 2, the hydrogen chloride gas, a by-product of the reaction, is eliminating, causing visually seen bubbling. Reaction is over when the bubbling stops. Then more initiator can be added. Addition of the initiator solution should be gradual, and preferably portion-wise, to let the catalyst react within its dwell time in the Reaction Vessel 2. Preferably Vessel 2 should be made of glass or contain a sight-glass to allow visual control. A glass distillate receiver tube in a standard distillation vessel would be suitable as Vessel 2.

Alternative ways of monitoring the reaction progress could be employed, such as by measuring the HCl amount in the exhaust, or by monitoring the temperature in Vessels 1 and 2, and the temperature in the exhaust lines.

Preferably, Vessel 1 should be heated to maintain a high rate of reflux, to quickly remove the reaction product and the by-products from Vessel 2 by fast turnover of the distillate. The rate of initiator addition should be tied-in with the rate of reflux. Faster reflux rate allows faster initiator addition and results in quicker conversion.

The temperature in the Vessel 2 should preferably be just below the boiling point of the mixture.

Another use for the set-up shown in FIG. 2 is in grafting Group 1 reagent onto insoluble Group 2 polymers, like cellulose fibers or crosslinked polymers, or even articles. These substrates can be placed into the Reaction Vessel 2, which can be configured as a Soxhlet extractor, and the tetrachloroethylene can be circulated in reflux, while the catalyst solution is gradually added to the Reaction Vessel 2.

Another embodiment for the set-up is by using a fractionation column with liquid-retaining filler, or with high surface area filler instead of the Vessel 2. Again, the purpose is to increase the dwell time of the initiator in the condensate, before it falls back into the Vessel 1.

If the Group 2 reagent has much higher boiling point than the Group 1 reagent, one should be especially careful not to add too much catalyst solution at once, since Group 1 reagent in the catalyst solution would depress the boiling point of the mixture, and the Group 2 reagent will remain in the Vessel 1, instead of refluxing. This would defeat the purpose of this set-up. With Group 2 reagent boiling about 60° C. higher than the Group 1 reagent the standard set-up should be preferably used.

Recovering the product: At the end of the grafting reaction the lower-boiling unreacted reagents can be removed by vacuum distillation, and the higher-boiling product remains in the pot. It can then be distilled in vacuum. When the substrate is a polymer, then the grafted product can be simply recovered by precipitation in methanol.

Solubility considerations: Some Group 2 reagents and polymers are not soluble in Group 1 reagents. Then the reaction is conducted in suspension. However, as the grafting progresses, these polymers become more soluble, and may dissolve completely. Alternatively, cosolvents like toluene, xylene or chlorobenzene may be employed. Any solvent may be used, provided it does not have active hydrogen groups that would compete with the substrate active methylene groups for free-radicals.

### EXAMPLES

### Example 1

### Ethyl acetate—Tetrachloroethylene Reaction Standard Set-Up

88 grams ethyl acetate and 166 grams tetrachloroethylene were refluxed under nitrogen atmosphere, while 5.0 grams benzoyl peroxide dissolved in 330 grams tetrachloroethylene were gradually added during 4 hours. The reflux temperature has gradually increased from 77 to 89° C. during the reaction time, and hydrogen chloride gas elimination was observed. Then the heat was increased, and un-reacted reagents were distilled off until the pot temperature has reached 100° C. Then the pot residue was fractionated in vacuum at 100° C. 137 grams product was obtained. Analysis showed the presence of initial adduct 2,2,3,3-tetrachloro-1-methylpropyl acetate, along with the dehydrochlorinated product 2,3,3-trichloro-1-methylprop-2-enyl acetate. On further refluxing at 100° C. in vacuum more HCl was eliminated, and the final product contained only 2,3,3-trichloro-1-methylprop-2-enyl acetate.

### Example 2

### Ethyl Acetate—Tetrachloroethylene Preferred Reaction Set-Up

88 grams ethyl acetate, 166 grams tetrachloroethylene and 0.25 gram phenothiazine were placed in a reactor built according to the schematics in FIG. 2 and were refluxed under nitrogen atmosphere, while 5.0 grams benzoyl peroxide dissolved in 330 grams tetrachloroethylene were gradually added through the addition funnel to the reaction Vessel 2 in the course of 10 hours. The reflux temperature has gradually increased from 77 to 110° C. during the reaction time, and hydrogen chloride gas elimination was observed. Then the reaction mixture was fractionated in vacuum at 100° C. On further refluxing at 100° C. in vacuum more HCl was eliminated. The final product contained 196 grams 2,3,3-trichloro-1-methylprop-2-enyl acetate.

### Example 3

### Ethyl butyrate—Tetrachloroethylene Reaction Standard Set-Up

116 grams ethyl butyrate and 166 grams tetrachloroethylene were refluxed under nitrogen atmosphere, while 5.0 grams benzoyl peroxide dissolved in 330 grams tetrachloroethylene were gradually added during 4 hours. Hydrogen chloride gas elimination was observed. Then vacuum was applied, and un-reacted reagents were distilled off. Then the pot residue was fractionated in vacuum at 100° C. 167 grams product was obtained. Analysis showed the presence 2,3,3-trichloro-1-methylprop-2-enyl butyrate.

### Example 4

### Ethyl butyrate—Tetrachloroethylene Preferred Reaction Set-Up

116 grams ethyl butyrate, 166 grams tetrachloroethylene and 0.25 gram phenothiazine (a free-radical inhibitor) were placed in a reactor built according to the schematics in FIG. 2 and were refluxed under nitrogen atmosphere, while 5.0 grams benzoyl peroxide dissolved in 330 grams tetrachloroethylene were gradually added through the addition funnel to the reaction Vessel 2 in the course of 10 hours. Hydrogen chloride gas elimination was observed.

Then the reaction mixture was fractionated in vacuum at 100° C. The product contained 206 grams 2,3,3-trichloro-1-methylprop-2-ethyl butyrate.

### Example 5

### Gamma-Butyrolactone—Tetrachloroethylene

Reaction 86 grams gamma-butyrolactone and 130 grams tetrachloroethylene were refluxed at 100-120° C. under slight vacuum in nitrogen atmosphere, while 5.0 grams benzoyl peroxide dissolved in 200 grams tetrachloroethylene were gradually added during 4 hours. During the reaction time hydrogen chloride gas elimination was observed. Then the heat was increased, and excess tetrachloroethylene was distilled off in vacuum. 160 grams 5-(trichlorovinyl)dihydrofuran-2(3H)-one was obtained.

### Example 6

### Dioxane—Tetrachloroethylene Reaction

88 grams dioxane and 166 grams tetrachloroethylene were refluxed at 100-120° C. in nitrogen atmosphere, while 5.0 grams benzoyl peroxide dissolved in 330 grams tetrachloroethylene were gradually added during 4 hours.

During the reaction time hydrogen chloride gas elimination was observed and the reflux temperature have increased. Then the heat was increased, and excess tetrachloroethylene was distilled off in vacuum. 123 grams product was obtained.

### Example 7

### Tetrachloroethylene—Cellulose Diacetate Graft Copolymer

40 grams cellulose diacetate flakes and 300 grams tetrachloroethylene were stirred overnight, then the mixture was heated with stirring for 30 minutes at 100° C. under nitrogen atmosphere to remove traces of water, then 2.5 grams benzoyl peroxide dissolved in 200 grams tetrachloroethylene were gradually added during 4 hours. During the reaction time hydrogen chloride gas elimination was observed. Then the mixture was poured in 1 liter methanol to recover the polymer. The precipitated polymer was filtered, washed and dried overnight under vacuum at 70° C. 62 grams of graft copolymer was obtained.

### Example 8

### Tetrachloroethylene—Cellulose Graft Copolymer

40 grams cellulose fibers were placed into the Soxhlet extractor tube that served as a reactor 2 as in FIG. 2, and 100 grams tetrachloroethylene was refluxing at 120° C. for 30 minutes to remove traces of water, then 5.0 grams benzoyl peroxide dissolved in 500 grams tetrachloroethylene were gradually added during 4 hours. Slight vacuum was applied, so the tetrachloroethylene was refluxing at 100-105° C. during the reaction. During the reaction time hydrogen chloride gas elimination was observed. Then still insoluble product was removed and dried. 42 grams of graft copolymer was obtained.

### Example 9

### Tetrachloroethylene—Polyvinyl Acetate Graft Copolymer

40 grams polyvinyl acetate and 300 grams tetrachloroethylene were stirred overnight, then the mixture was heated with stirring at 100° C. under nitrogen atmosphere, while 5.0 grams benzoyl peroxide dissolved in 200 grams tetrachloroethylene were gradually added during 4 hours. During the reaction time hydrogen chloride gas elimination was observed. Then the mixture was poured in 1 liter methanol to recover the polymer. The precipitated polymer was filtered, washed and dried overnight under vacuum at 70° C. 62 grams of graft copolymer was obtained.

### Example 10

### Tetrachloroethylene Polyethylacrylate Graft Copolymer

40 grams polyethylacrylate and 300 grams tetrachloroethylene were stirred overnight, then the mixture was heated with stirring at 100° C. under nitrogen atmosphere, while 5.0 grams benzoyl peroxide dissolved in 200 grams warm tetrachloroethylene were gradually added during 4 hours. During the reaction time hydrogen chloride gas elimination was observed. Then the mixture was poured in 1 liter methanol to recover the polymer.

The precipitated polymer was filtered, washed and dried overnight under vacuum at 70° C. 62 grams of graft copolymer was obtained.

### Example 11

### Soybean Oil Reaction with Tetrachloroethylene

60 grams soybean oil and 300 grams tetrachloroethylene were heated with stirring at 100° C. under nitrogen atmosphere, while 5.0 grams benzoyl peroxide dissolved in 200 grams tetrachloroethylene were gradually added during 4 hours. During the reaction time hydrogen chloride gas elimination was observed. Then the heat was increased, and excess tetrachloroethylene was distilled off in vacuum until the pot temperature has reached 120° C. 87 grams modified oil was obtained.

### Example 12

### Ethyl caprate—hexachlorocyclopentadiene Reaction

100 grams ethyl caprate (decanoate) and 137 grams hexachlorocyclopentadiene were refluxed in vacuum at 100-110° C. under nitrogen atmosphere, while 5.0 grams benzoyl peroxide dissolved in200 grams hexachlorocyclopentadiene were gradually added during 4 hours. Hydrogen chloride gas elimination was observed. Then vacuum was applied, and unreacted reagents were distilled off. Then the pot residue was fractionated in high vacuum at 100° C. 162 grams product was obtained.

Obviously, numerous variations and modifications can be made without departing from the spirit of the present invention. Therefore, it should be clearly understood that the form of the present invention described above and shown in the figures of the accompanying drawing is illustrative only and is not intended to limit the scope of the present invention.

1. A process and the products of the reaction, comprising reacting compounds referred to herein as Group 1 reagents, selected from a group of tetrachloroethylene, trichloroethylene, mixed tetrahaloethylenes, hexachlorocyclopentadiene and hexachlorobutadiene, with compounds referred to herein as Group 2 reagents, selected from a group of compounds, polymers and articles which have at least one methylene or methyne group which is adjacent to at least one electron withdrawing group selected from a group of ester, ether, carbonyl, nitrile, amide, nitro, sulfoxy, carbamyl, hydroxyl, or an aromatic ring groups, in the presence of free radicals, free radical initiators or their precursors, or when free radicals are created using ultrasound, UV light, ionizing radiation, and the like.

2. The method and the products of claim 1, wherein the Group 2 reagent is selected from a group of compounds, polymers and articles containing ethers and esters of alcohols containing methylene or methyne group adjacent to oxygen with carboxylic, inorganic, or polymeric acids; ketones, polyesters, polyester polyols, polyethers, polyether polyols, and polyurethanes made with these polyols; poly-alkylacrylates, poly-alkylmethacrylates, poly-hydroxyalkylacrylates, poly-hydroxyalkylmethacrylates; polycarbonates made from aliphatic diols; alkyl carbonates, beta-ketoesters, beta-diketones, beta-dialkyl malonates, beta-diaryl malonates, cyclic esters and ethers, oxiranes, polylactones, ethylene-carbon monoxide copolymers; polymers and copolymers of polypropylene oxide and polyethylene oxide, polyvinyl acetate and its derivatives; ethylene-vinyl acetate copolymers, carbohydrates, polycarbohyd rates, cellulose esters and ethers.

3. The method and the products of claim 1, wherein the Group 2 reagent is selected from a group of compounds, polymers and articles containing 1,4-dioxane, ethyl formate, propyl formate, butyl formate, isobutyl formate, amyl formate, methyl acetate, ethyl acetate, propyl acetate, isopropyl acetate, butyl acetate, isobutyl acetate, secondary butyl acetate, amyl acetate, isoamyl acetate, methylisoamyl acetate, methoxybutyl acetate, 2-ethylbutyl acetate, hexyl acetate, cyclohexyl acetate, benzyl acetate, methyl propionate, ethyl propionate, butyl propionate, amyl propionate, methyl butyrate, ethyl butyrate, butyl butyrate, amyl butyrate, isoamyl butyrate, methyl acetoacetate, ethyl acetoacetate, ethyl acetone acetate, isoamyl isovelerate, methyl lactate, ethyl lactate, butyl lactate, amyl lactate, methyl benzoate, diethyl oxalate, ethylene glycol, ethylene glycol monomethyl ether, ethylene glycol monomethyl ether acetate, ethylene glycol dimethyl ether, ethylene glycol monoethyl ether, ethylene glycol diethyl ether, ethylene glycol monoethyl ether acetate, ethylene glycol isopropyl ether, ethylene glycol monobutyl ether, ethylene glycol monoisobutyl ether, ethylene glycol dibutyl ether, ethylene glycol monobutyl ether acetate, ethylene glycol isoamyl ether, ethylene glycol monohexyl ether, ethylene glycol monophenyl ether, ethylene glycol monophenyl ether acetate, ethylene glycol benzyl ether, methoxymethoxyethanol, ethylene glycol monoacetate, ethylene glycol diacetate, ethylene glycol butyric monoester, ethylene glycol propionic diester, ethylene glycol butyric diester, diethylene glycol, diethylene glycol monomethyl ether, diethylene glycol monoethyl ether, diethylene glycol monomethyl ether acetate, diethylene glycol monoethyl ether acetate, diethylene glycol monoisopropyl ether, diethylene glycol monobutyl ether, diethylene glycol monoisobutyl ether, diethylene glycol monobutyl ether acetate, diethylene glycol dimethyl ether, diethylene glycol diethyl ether, diethylene glycol methyl ethyl ether, diethylene glycol acetate, diethylene glycol dibutyl ether, propylene glycol, propylene glycol monomethyl ether, propylene glycol monoethyl ether, propylene glycol monomethyl ether acetate, propylene glycol propyl ether, propylene glycol monoethyl ether acetate, propylene glycol monobutyl ether, dipropylene glycol, dipropylene glycol monomethyl ether, dipropylene glycol monoethyl ether, dipropylene glycol dimethyl ether, dipropylene glycol methyl ethyl ether, dipropylene glycol diethyl ether, trimethylene glycol, triethylene glycol dimethyl ether, butanediol, pentanediol, hexylene glycol, 3-methoxy-3-methoxybutanol, triethyl phosphate, .gamma.-butyrolactone, .gamma.-valerolactone, 6-hexanolactone, ethyl salicylate, butyl salicylate, diethyl adipate, ethyl carbonate, butyl sulfide, acetylacetone, ethyl acetate, ethyl propionate, ethyl butyrate, propyl acetate, iso-propyl acetate, n-butyl acetate, sec-butyl acetate, amyl acetate, benzyl acetate, hexyl acetate, heptyl acetate, octyl acetate, decyl acetate, dodecyl acetate, hexadecyl acetate, 1-methoxy-2-propanol acetate, butyl phthalate, benzyl acetate, furfuryl acetate, tetrahydrofurfuryl acetate, polyethylene terephthalate, epichlorohydrine, epoxy resins, gamma-butyrolactone, hydroxy-gamma-butyrolactone, acetoxy-gamma-butyrolactone, tetrahydrofurane, morpholine, N-methylmorpholine, N-methylmorpholine N-oxide, 4-alkylmorpholine, diethyl ether, isopropyl ether, dibutyl ether, diisoamyl ether, hexyl ether, ethyl phenyl ether, butyl phenyl ether, ethyl benzyl ether, 2-methylfuran, tetrahydrofuran, tetrahydropyran, 2-ethoxytetrahydropyran, acetone, methyl ethyl ketone, cineole, acetone, methyl propyl ketone, methyl butyl ketone, methyl isobutyl ketone, methyl amyl ketone, methyl hexyl ketone, diethyl ketone, ethyl butyl ketone, dipropyl ketone, diisobutyl ketone, diacetone alcohol, phorone, isophorone, cyclohexanone, methylcyclohexanone, acetophenone, 1,3-diphenyl-2-propanone, benzoylacetonitrile, hydrocinnamonitrile, dibenzyl sulfoxide, ethylvinyl sulfone, dialkyl sulfone, alkylphenyl sulfone, acetonitrile, cyanoacetamide, and 1,3-cyclohexanedione, polyvinyl benzoate, polyvinyl propionate, polyvinyl butyrate, polyvinyl phthalate, fatty acid mono-, di-, and triglycerides, other glycerol esters and ethers, pentaerytritol esters and ethers, glucose, sucrose, sucrose esters, acetyl cellulose, alkyl, alkylhydroxyalkyl, hydroxyalkyl, and carboxyalkyl cellulose ethers, polybutene-1,4-diol, poly-beta-hydroxybutyrate, polylactide, polylactic acid, caprolactone, polycaprolactone.

4. The method of claim 1, wherein the equivalent ratio between the Group 1 reagent and the active methylene groups in Group 2 reagent is between 1000:1 and 1:5.

5. The method of claim 1, wherein the weight ratio between the free radical initiator and the Group 2 reagent is between 1:1000 and 1:5.

6. The method of claim 1, wherein the reaction temperature is between 20 and 150° C.

7. The method of claim 1, wherein the reaction pressure is between 0.01 and 50 atmospheres.

8. The method of claim 1, wherein said reacting step is carried out for a time of about 1 to 50 hours.

9. The process including two vessels, Vessel 1 and Vessel 2, connected to allow the passage of vapors from Vessel 1 to Vessel 2 and the passage of liquids from Vessel 2 to Vessel 1, wherein the reagents are intermittently or continuously heated and distilled from the Vessel 1 and condensed into Vessel 2, then return as a liquid to the Vessel 1, wherein the catalysts, the reagents, or any combination of them are added to the Vessel 2 in a portion-wise or continuous way.

10. The process of claim 9, wherein the initial molar ratio of the Group 2 reagent to the Group 1 reagent (M2/M1) in the Vessel 1 is approximately the inverse of the ratio of the vapor pressures of the Group 2 reagent (VP2) to the Group 1 reagent (VP1), according to the formula: M2/M1=VP1/VP2.

11. The process of claim 9, wherein the initial molar ratio of the Group 2 reagent to the Group 1 reagent (M2/M1) in the Vessel 2 is approximately 1:1.

12. The process of claim 9, wherein Vessel 2 contains the insoluble Group 2 reagent.

13. The process of claim 9, wherein Vessel 1 further contains free radical inhibitor or a mixture of inhibitors.

14. The process of claim 9, wherein Vessel 1 or the Vessel 2 further contains a base, or an inorganic peroxide, or an acid scavenger.

15. The process of claim 9, wherein the Vessel 1 or the Vessel 2 further contains a base selected from a group of alkali or alkali earth metal oxide, peroxide, hydroxide, carbonate, bicarbonate, aluminum hydroxide, or an organic or polymeric base or acid scavenger.

16. The method of claim 9, wherein the equivalent ratio between the Group 1 reagent and the active methylene groups in Group 2 reagent is between 1000:1 and 1:5.

17. The method of claim 9, wherein the weight ratio between the free radical initiator and the Group 2 reagent is between 1:1000 and 1:5.

18. The method of claim 9, wherein the reaction temperature is between 20 and 150° C.

19. The method of claim 9, wherein the reaction pressure is between 0.01 and 50 atmospheres.

20. A method of claim 9, wherein the reagents and the catalyst are being added intermittently or continuously to the Vessel 2 and the reaction mixture is being removed intermittently or continuously from the Vessel 1.
